(19) United States
(12) Patent Application Publication
(10) Pub. No.: US 2010/0014793 A1
(43) Pub. Date: Jan. 21, 2010

(54) BEARING ARRANGEMENT, PARTICULARLY OF A VEHICLE SEAT

(76) Inventor: Thomas Bingert, Otterbach (DE)

Correspondence Address: MCGLEW & TUTTLE, PC, P.O. BOX 9227, SCARBOROUGH STATION, SCARBOROUGH, NY, 10510-9227, US

(21) Appl. No.: 12/446,631

(22) PCT Filed: Dec. 4, 2007
(86) PCT No.: PCT/EP07/10495

§ 371 Date: Apr. 22, 2009

(30) Foreign Application Priority Data
Dec. 22, 2006 (DE) 10-2006-060-829.1

(51) Int. Cl. F16C 33/02; B60N 2/02

(52) U.S. Cl. 384/276; 296/65.01

(57) ABSTRACT

A bearing arrangement (5) between two components (9, 12) that can be pivoted relative to each other about an axis (A), particularly of a vehicle seat (1), has two bearing elements (7, 10) that can be pivoted relative to each other about the axis (A), and a bushing (20) that is disposed axially and/or radially between the bearing elements (7, 10). The bushing has resilient sections (20a, 20b) for the axial and/or radial compensation for play. The bushing (20) has a disk section (20a) acting as a disk spring for the axial compensation of play, and a barrel section (20b) acting as a barrel spring for the radial compensation of play.

### CROSS REFERENCE TO RELATED APPLICATIONS

This application is a United States National Phase application of International Application PCT/EP2007/010495 and claims the benefit of priority under 35 U.S.C. § 119 of German Patent Application DE 10 2006 060 829.1 filed Dec. 22, 2006, the entire contents of which are incorporated herein by reference.

### FIELD OF THE INVENTION

The invention relates to a bearing arrangement between two components, in particular of a vehicle seat, which can pivot relative to one another about an axis, having two bearing elements which can pivot relative to one another about the axis and a bearing bushing which is arranged axially and/or radially between the bearing elements.

### BACKGROUND OF THE INVENTION

DE 299 24 397 U1 discloses a bearing arrangement of this type having a bearing position and a pipe as bearing elements, in which bearing arrangement the bearing position holds in a rotationally fixed fashion a bearing bushing which is made of plastic and into which the pipe is inserted. Projecting elastic elements are integrally formed on the bearing bushing and they bear against the pipe in order to prestress it in the axial and radial directions and/or to center it. This compensates play which is present. In DE 103 29 237 A1, a bearing arrangement having a bearing position and a bolt as bearing elements is proposed, in which bearing arrangement initially undeformed deformation areas are provided at the bearing position and said deformation areas are deformed plastically before or after mounting in order to bear against the bolt and support it free of play.

### SUMMARY OF THE INVENTION

The invention is based on the object of improving a bearing arrangement of the type mentioned at the beginning. This object is achieved according to the invention by means of a bearing arrangement having two bearing elements which can pivot relative to one another about an axis and a bearing bushing which is arranged axially and/or radially between the bearing elements and which has resilient sections for axial and/or radial compensation of play. The bearing bushing has a disk section providing an axial compensation of play and a barrel section providing a radial compensation of play.

As a result of the fact that the bearing bushing has a disk section which acts as a disk spring for axial compensation of play and a barrel section which acts as a barrel spring for radial compensation of play, a compact and robust component is made available which is easy to manufacture and to mount and can also combine a plurality of functions in itself.

The compensation of play is effected by building up prestress when the bearing arrangement is assembled, on the basis of elastic deformation of the sections of the bearing bushing, with each section being preferably assigned to precisely one direction for the compensation of play. The deformation is preferably brought about by virtue of the fact that the dimensions of the bearing bushing are larger in the direction of the assembling process, generally the axial direction, than the corresponding dimensions of the bearing elements, their sections and/or the components. As a result, compression occurs in the axial direction and widening occurs in the radial direction.

For an easily joined press fit which is difficult to release again, the bearing bushing preferably has at least one projection toward a bearing element, which projection initially deforms owing to the movement when assembly occurs but digs into the rough surface of the bearing element and therefore prevents disassembly.

The invention will be explained in more detail below on the basis of an exemplary embodiment which is illustrated in the drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a sectional view through the exemplary embodiment according to the invention;

FIG. 2 is a schematic side view of a vehicle seat with a bearing arrangement according to the invention;

FIG. 3 is a perspective view of the exemplary embodiment;

FIG. 4 is an exploded illustration of the bearing arrangement shown in FIG. 3;

FIG. 5 is a side view of the bearing bushing according to the invention;

FIG. 6 is a side view of the bearing bushing according to the invention;

FIG. 7 is a sectional view along the line VII-VII in FIG. 6; and

FIG. 8 is an enlarged view of the region VIII in FIG. 7.

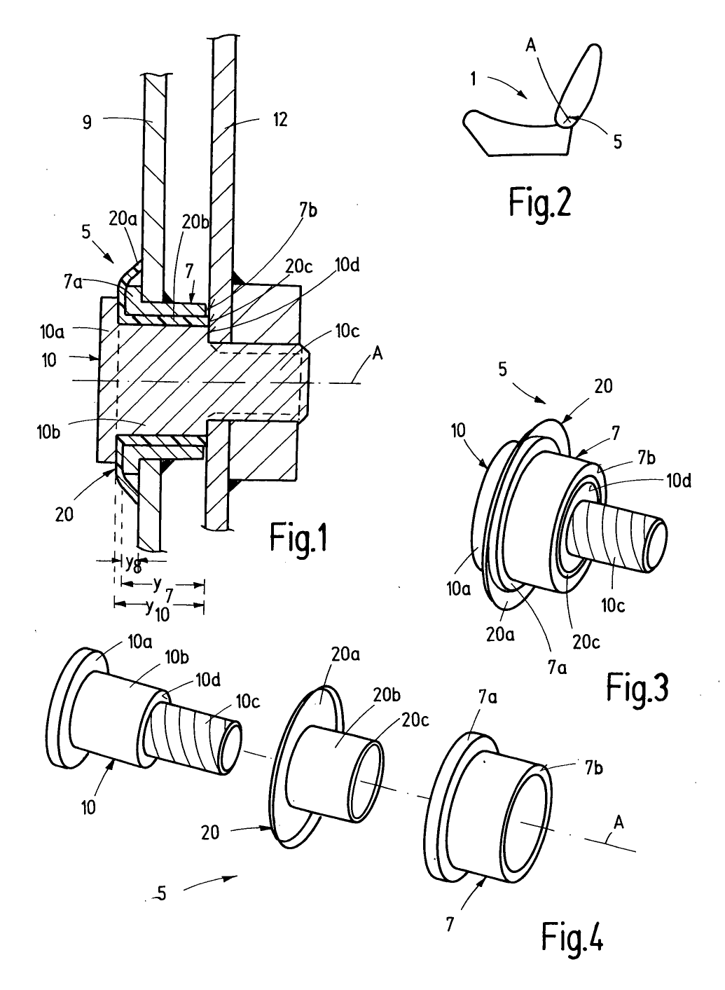

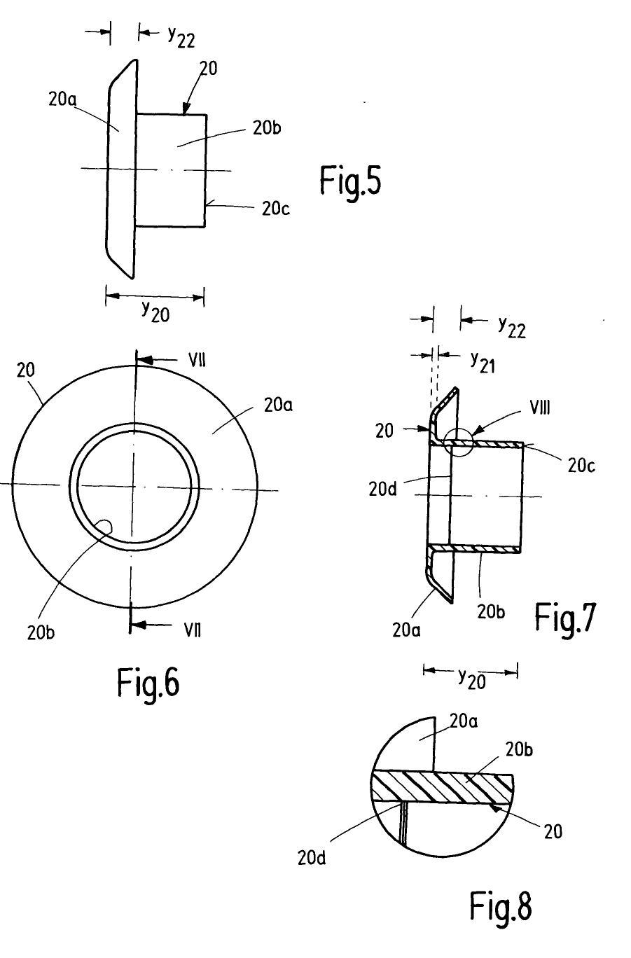

### DESCRIPTION OF THE PREFERRED EMBODIMENT

Referring to the drawings in particular, a vehicle seat 1 of a motor vehicle has a bearing arrangement 5 at least between two components which can pivot relative to one another. Such components can be, for example, the rockers, bearing blocks and seat frame side components of a vertical adjuster. The vehicle seat 1 preferably has a plurality of the bearing arrangements 5 which are embodied according to the invention.

The bearing arrangement 5 comprises a first bearing element 7 in the form of a receptacle, hollow bushing or the like, which is formed in a first component 9 of the two components or assigned to it, and a second bearing element 10 in the form of a bolt, pipe, cylindrical section or the like, which forms the second component 12, is formed thereon or is assigned to it in some other way. In the mounted state, the first bearing element 7 which is arranged on the outside encloses the second bearing element 10 which is arranged on the inside. The two bearing elements 7 and 10 have a cross section about the pivot axis A which is circular with respect to the relative pivot axis A of the two bearing elements 7 and 10. The pivot axis A defines the directional information (radial and axial directions) used herein.

The first bearing element 7 is embodied as a, preferably metallic, bushing and has a first flange 7a on one end side and a first bearing face 7b on the opposite end side. The axial length of the first bearing element 7, i.e. the distance between the end side with the first flange 7a and the first bearing face 7b, is denoted by y7. The first component 9 is a component of the structure of the seat part of the vehicle seat 1 which is flat in the region of the bearing arrangement 5 and has an opening into which the first bearing element 7 is pressed to such an extent that the first flange 7a bears against the first component 9. On the other side of the first component 9, the first bearing element 7 can be welded to the first component 9.

The second bearing element 10 is embodied as a, preferably metallic, bolt. The second bearing element 10 has a second flange 10a on an end side, axially adjoining a collar 10b and a threaded section 10c which axially adjoins the latter and has an external thread. The diameter of the collar 10b is larger than the diameter of the threaded section 10c. The shoulder owing to this difference in diameter defines a second bearing face 10d. The axial length of the collar 10b, i.e. the distance between the side of the second flange 10a, located toward the collar 10b, and the second bearing face 10d is denoted by y10. The second component according to this embodiment is an element of the structure of the backrest of the vehicle seat 1 which is flat in the region of the bearing arrangement 5 and has a weld nut or some other internally threaded carrier. The second bearing element 10 has to be screwed with its threaded section 10c into the second component 12 until the collar 10b comes to bear, with the shoulder adjoining the threaded section 10c, against the second component 12. The bearing arrangement 5 therefore forms a rotary bearing for the backrest.

A bearing bushing 20 is provided for radial, and in certain areas axial, arrangement between the two bearing elements 7 and 10. The bearing bushing 20 is preferably composed of plastic. The bearing bushing 20 which is manufactured in one piece has a mushroom-like shape with a disk-shaped head, referred to below for short as disk section 20a, and an axially adjoining hollow section, referred to below for short as barrel section 20b. The end side of the barrel section 20b which faces away from the disk section 20a defines a third bearing face 20c. The axial length of the bearing bushing 20, i.e. the distance between the end side, facing away from the barrel section 20b, of the disk section 20a and the third bearing face 20c is denoted by y20. The axial material thickness of the disk section 20a is denoted by y21. The axial length of the disk section 20a, that is to say the axial distance between the end side of the bearing bushing 20 and the edge of the disk section 20a which is located on the outside is denoted by y22. Near to the disk section 20a, the hollow barrel section 20b has, on its inner side, at least one projection 20d which projects into the interior of the barrel section 20b and has a very small dimension in the radial direction compared to the internal diameter of the barrel section 20b. The integrally formed projection 20d preferably runs around once in the circumferential direction as an annular bead, but it can also be embodied in the form of knobs, claws or other island-like portions of material.

The bearing bushing 20 is conceived in such a way that it simultaneously performs three functions, which are described below. In order to assemble the bearing position 5, the bearing bushing 20 is pushed onto the second bearing element 10, i.e. with the disk section 20a in front the barrel section 20b is pushed onto the collar 10b from the threaded section 10c until the disk section 20a comes to bear, with the end side of the bearing bushing 20, against the second flange 10a, as a result of which a bearing bolt assembly is produced. The projection 22 deforms—elastically and/or plastically—during this movement in such a way that although the bearing bushing 20 can initially easily be pushed onto the collar 10b, after this the projection 20d and the rough surface of the collar 10b dig into one another so that the bearing bushing 20 can no longer come away. The first function of the bearing bushing 20 is therefore an easily joined press fit.

The bearing bolt assembly is then introduced into the first bearing element 7 which is arranged permanently in the first component 9, in which case radial play is generally present owing to tolerances. The threaded section 10c is then screwed into the second component 12. The axial length y20 of the bearing bushing 20 is selected to be somewhat larger than the axial length y10 of the collar 10b. The bearing bushing 20 therefore comes to bear, with its third bearing face 20c, against the second component 12 before the second bearing element 10 comes to bear, with the second bearing face 10d on the collar 10b, against the second component 12. Under the pressure which builds up, the barrel section 20b begins to deform elastically to form a barrel until the second bearing face 10d comes to bear against the second component 12. This barrel spring which is formed in this way and is prestressed by compression eliminates the radial play between the bearing bushing 20 and the first bearing element 7. This is the second function of the bearing bushing 20.

The axial length y7 of the first bearing element 7 is selected to be somewhat smaller than the axial length y10 of the collar 10b minus the axial material thickness y21 of the disk section 20a of the bearing bushing 20, so that the first bearing element 7 is not screwed in a nonmovable fashion to the second component 12 but rather axial play is available for the relative movement. On the other hand, the axial length y22 of the disk section 20a is selected to be somewhat larger than the sum of the axial material thickness y8 of the first flange 7a and the axial material thickness y21 of the disk section 20a, and the disk section 20a is configured to engage over the first flange 7a. The disk section 20a therefore comes to bear with its edge against the first component 9 before the disk section 20a comes to bear against the first flange 7a, i.e. the end side of the first bearing element, or the first bearing face 7b comes to bear against the second component 12. Under the pressure which builds up, the disk section 20a begins to deform elastically until the first bearing face 7b comes to bear against the second component 12. This prestressed disk spring which is formed in this way eliminates the axial play between the two bearing elements 7 and 10 and components 9 and 12. This is the third function of the bearing bushing 20.

While a specific embodiment of the invention has been shown and described in detail to illustrate the application of the principles of the invention, it will be understood that the invention may be embodied otherwise without departing from such principles.

1. A bearing arrangement between two components of a vehicle seat, which can pivot relative to one another about an axis, the bearing arrangement comprising:
two bearing elements which can pivot relative to one another about the axis; and
a bearing bushing arranged axially and/or radially between the two bearing elements, said bearing bushing having resilient sections for axial and/or radial compensation of play, including a disk section acting as a disk spring for axial compensation of play and a barrel section acting as a barrel spring for radial compensation of play.

2. The bearing arrangement as claimed in claim 1, wherein the axial dimensions of the bearing bushing and of its sections are larger, before the assembly of the bearing arrangement, than corresponding axial dimensions of the bearing elements and of their sections.

3. The bearing arrangement as claimed in claim 1, wherein the first bearing element is permanently connected to the first component by one or more of a pressing in connection and a weld connection.

4. The bearing arrangement as claimed in claim 1, wherein the second bearing element is screwed into the second component by means of a threaded section.

5. The bearing arrangement as claimed in claim 1, wherein, when is the bearing arrangement assembled, the disk section and/or the barrel section come to bear in the radial direction against the first component or the second component and deform elastically with compression in the axial direction, as a result of the pressure which builds up, resulting in prestress being built up for the axial and/or radial compensation of play.

6. The bearing arrangement as claimed in claim 1, wherein, when the bearing arrangement is assembled, the second bearing element is plugged in the axial direction, with intermediate positioning of the bearing bushing, through the first bearing element, and is connected to the second component.

7. The bearing arrangement as claimed in claim 6, wherein, when the bearing arrangement is assembled, the bearing bushing is pushed onto the second bearing element before the assembly which is formed in this way is plugged through the first bearing element.

8. The bearing arrangement as claimed in claim 7, wherein the bearing bushing has, on its inner side, at least one projection by means of which an easily joined press fit is produced.

9. The bearing arrangement as claimed in claim 1, wherein, on the end side facing the second component, the first bearing element is provided with a first bearing face and/or the second bearing element is provided with a second bearing face, wherein, when the bearing arrangement is assembled, the bearing bushing comes to bear with a third bearing face against the second component before the first bearing element comes to bear with its first bearing face, and/or the second bearing element comes to bear with its second bearing face, against the second component.

10. The bearing arrangement as claimed in claim 1, wherein, when the bearing arrangement is assembled, the disk section comes to bear with its edge against the first component, before the disk section comes to bear against the end side of the first bearing element or the first bearing element comes to bear against the second component.

11. A vehicle seat comprising:
two vehicle seat components for pivoting relative to one another; and
a bearing arrangement comprising two bearing elements which can pivot relative to one another about the axis, each bearing element being fixed to one of said two vehicle seat components and a bearing bushing arranged axially and/or radially between the two bearing elements, said bearing bushing having a resilient disk section acting as a disk spring for axial compensation of play and a resilient barrel section acting as a barrel spring for radial compensation of play.

12. A bearing arrangement comprising:
a first vehicle seat component;
a first bearing element connected to said first vehicle seat component and having an axially extending portion with a radially inner bearing surface and a radially extending portion with an axially outer bearing surface;
a second vehicle seat component;
a second bearing element connected to said second vehicle seat component, said first vehicle seat component having an axially extending portion with a radially outer bearing surface and a radially extending portion with an axially inner bearing surface; and
a bearing bushing with a disk section with a spring action for axial compensation of play between said first bearing element with connected first vehicle seat component and said second bearing element with connected second vehicle seat component, said disk section being arranged axially between said axially inner bearing surface and said axially outer bearing surface and with a barrel section with a spring action for radial compensation of play between said first bearing element with connected first vehicle seat component and said second bearing element with connected second vehicle seat component, said barrel section being arranged radially between said radially outer bearing surface and said radially inner bearing surface.

13. The bearing arrangement as claimed in claim 12, wherein:
a first component permanent connection is provided between said first bearing element and said first component with said radially extending portion of said first bearing element extending adjacent to a surface of said first vehicle seat component and said disk section extending radially outwardly from said radially extending portion of said first bearing element to contact said surface of said first vehicle seat component; and
a second component permanent connection is provided between said second bearing element and said second component.

14. The bearing arrangement as claimed in claim 13, wherein:
said first component permanent connection comprises at least one of a press fit connection and a weld connection; and
said second component permanent connection comprises a second bearing element threaded section screwed into said second component.

15. The bearing arrangement bushing as claimed in claim 13, wherein prior to assembly of the bearing arrangement:
the bearing bushing has a disk axial dimension from between said radially extending portion of said first bearing element and said radially extending portion of said second bearing element to said surface of said first vehicle seat component that is greater than an axial dimension of said radially extending portion of said first bearing element; and
the bearing bushing has an axial dimension that is longer than said first vehicle seat radially inner bearing surface;
the bearing bushing has an axial dimension that is longer than said second vehicle seat radially outer bearing surface.

16. The bearing arrangement as claimed in claim 15, wherein the disk section deforms elastically from between said radially extending portion of said first bearing element and said radially extending portion of said second bearing element to said surface of said first vehicle seat component to form a prestress.

17. The bearing arrangement as claimed in claim 15, wherein the barrel section deforms elastically from between said radially extending portion of said first bearing element and said radially extending portion of said second bearing element to a surface of said second vehicle seat component to form a prestress.

18. The bearing arrangement as claimed in claim 12, wherein the bearing bushing has an inner side with at least one projection forming a press fit between said bearing bushing has inner side an said radially outer bearing surface.
